(19) United States
(12) Patent Application Publication
(10) Pub. No.: US 2013/0178584 A1
(43) Pub. Date: Jul. 11, 2013

(54) COATING COMPOSITIONS

(71) Applicants: Xin Jin, Lake Jackson, TX (US); Ray E. Drumright, Midland, MI (US); Bernhard Kainz, Lauf (DE); Jerry E. White, Lake Jackson, TX (US); Robert E. Hefner, JR., Rosharon, TX (US)

(72) Inventors: Xin Jin, Lake Jackson, TX (US); Ray E. Drumright, Midland, MI (US); Bernhard Kainz, Lauf (DE); Jerry E. White, Lake Jackson, TX (US); Robert E. Hefner, JR., Rosharon, TX (US)

(73) Assignee: DOW GLOBAL TECHNOLOGIES LLC, MIDLAND, MI (US)

(21) Appl. No.: 13/816,772

(22) PCT Filed: Sep. 20, 2011
(86) PCT No.: PCT/US11/52236

§ 371 Date: Feb. 13, 2013

Related U.S. Application Data
(60) Provisional application No. 61/388,089, filed on Sep. 30, 2010.

(51) Int. Cl. C09D 167/02

(52) U.S. Cl. CPC C09D 167/025
USPC 524/601

(57) ABSTRACT

A coating composition comprising an advanced poly epoxy ester resin polymeric composition having the following chemical structure: where n is a number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical); Ar is a divalent aromatic fused-ring moiety, which is most preferably a divalent naphthalene group, substituted divalent naphthalene group, where the substitute groups include an alkyl, cycloalkyl, an aryl or an aralkyl group or other substituent; and X is cycloalkylene group, including substituted cycloalkylene group, where the substitute group include an alkyl, cycloalkyl, an aryl or an aralkyl group or other substitute group, for example, a halogen, a nitro, a blocked isocyanate, or an alkyloxy group; the combination of cycloalkylene and alkylene groups and the combination of alkylene and cycloalkylene group with a bridging moiety in between.

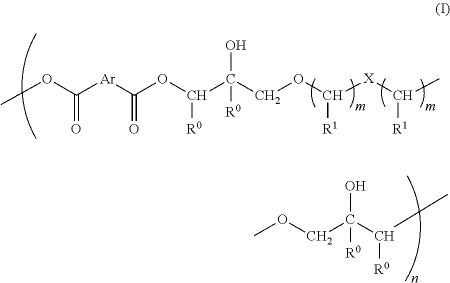

This application is a non-provisional application claiming priority from the U.S. Provisional Patent Application No. 61/388,089, filed on Sep. 30, 2010, entitled “COATING COMPOSITIONS” the teachings of which are incorporated by reference herein, as if reproduced in full hereinbelow.

### BACKGROUND OF THE INVENTION

1. Field of the Invention

The present invention relates to a coating composition comprising a high molecular weight poly epoxy ester resin composition which has been prepared from aromatic fused-ring dicarboxylic acid compounds and cycloaliphatic diglycidyl ether compounds. The coating compositions are useful, for example, as internal and external protective coating compositions for cans and other metal food and beverage packaging coatings.

2. Description of Background and Related Art

Epoxy resins are widely used in coating compositions of the interior and exterior surfaces of food and beverage containers because they provide a unique property combination of excellent resistance to chemicals, reasonable flexibility, resistance to hydrolysis, blush, corrosive food and beverages, having good thermal stability as well as inertness to taste or odor changes. A variety of manufacturing processes are used to apply such coatings to substrates. Flexibility and adhesion are advantageous properties because the coating should remain intact during the can formation process when the coated flat metal sheet is drawn into the form of the can. However, the bisphenol A based high molecular weight epoxy resins commonly used in can coating application have limited flexibility and toughness at room temperature. The elongation to break of bisphenol A based epoxy resins at room temperature is known to be poor. The toughness deficiency is an issue in certain applications, for example pre-coat post-form applications. Higher temperature is used in some can formation processing to compensate the relatively low flexibility of the incumbent epoxy resin coatings.

Retort resistance is another beneficial property for can coating compositions. When the cans are filled with food, the contents are usually sterilized by heating the sealed can to temperatures of around 120-130° C. for about 1 to 2 hours, depending on the nature of the food contents. The coating is then in direct contact with the food contents for a considerable period of time, for example many years. During the sterilization and subsequent storage, the coating maintains its integrity so as to prevent corrosion of the metal can and to prevent metal migration and migration from fragmented species of the coatings into the can contents.

Trends in the industry for improved flexibility without compromising retort resistance is open for alternative coating compositions meeting the technical challenges. Hydroxyl-functional poly epoxy ester resins are well known and are typically used as a coating for food containers. For example, WO 2008045882 and WO 2008045884 describe compositions and processes for the preparation of soluble epoxy ester resins from aromatic epoxy resins and dicarboxylic acids having a low acid number. WO 2008045894 and WO 2008045889 describe compositions and processes for the preparation of soluble epoxy ester resins from aromatic epoxy resins and dicarboxylic acids having a high acid number. None of the prior art processes disclose the use of a poly epoxy ester resin composition with improved elongation to break and increased tensile toughness.

### SUMMARY OF THE INVENTION

One embodiment of the present invention is directed to a curable coating composition comprising an advanced poly epoxy ester resin composition having the following chemical Structure (I):

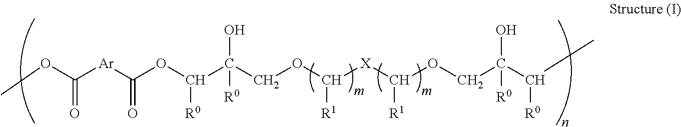

where n is a number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical); Ar is a divalent aromatic fused-ring moiety, which is most preferably a divalent naphthalene group, substituted divalent naphthalene group, where the substitute groups include an alkyl, cycloalkyl, an aryl or an aralkyl group or other substituent; and X is cycloalkylene group, including substituted cycloalkylene group, where the substitute group include an alkyl, cycloalkyl, an aryl or an aralkyl group or other substitute group, for example, a halogen, a cyano, a nitro, a blocked isocyanate, or an alkyloxy group; the combination of cycloalkylene and alkylene groups and the combination of alkylene and cycloalkylene group with a bridging moiety in between.

Another embodiment of the present invention includes wherein the above curable advanced poly epoxy ester resin coating composition comprises (i) the above advanced poly epoxy ester resin of Structure (I); (ii) at least one curing agent; (iii) optionally, at least one curing catalyst; (iv) optionally, at least one solvent and (v) optionally, at least other additives.

In one preferred embodiment, it has been found that cycloaliphatic diglycidyl ether compounds and aromatic fused-ring dicarboxylic acid compounds can be successfully used to make substantially linear high molecular weight poly epoxy ester resins, which have a high level of elongation at break and high tensile toughness and can be advantageously used in preparing the above curable coating composition.

Still another embodiment of the present invention is directed to a cured coating prepared by curing the above curable coating composition.

The present invention provides a coating and a method for preparing a coating having unusually high flexibility, good retort resistance, and excellent adhesion before and after retorting processes, good organic solvent resistance and good visual blush appearance useful for metal food and beverage packaging applications.

The coating of the present invention can be used in various coating applications such as for making can coatings, wherein high flexibility, good retort resistance, and excellent adhesion to the metal before and after retorting processes is desired, particularly when the can coating will be used for metal food packaging applications. The present invention advantageously provides a coating composition with improved flexibility without negatively impacting other coating properties, such as adhesion to substrates, solvent and retort resistance.

The flexibility of the cured coating compositions comprising the advanced high molecular weight poly epoxy ester resin of the present invention is demonstrated by Wedge Bend Flexibility measurement, its solvent resistance is characterized by Methyl Ethyl Ketone (MEK) Double Rubs Test, and its retort resistance and stable adhesion during the retort process is characterized by retort measurement in lactic acid solution. The Wedge Bend Flexibility results indicate that the cured coating compositions comprising the advanced high molecular weight poly epoxy ester resin of the present invention are more flexible than the cured bisphenol A based high molecular weight 9-type epoxy resin. MEK Double Rub results and retort resistance measurement illustrate that the cured coating compositions comprising the advanced high molecular weight poly epoxy ester resin in the present invention provide good chemical solvent resistance and retort resistance similar to the cured coating compositions of a bisphenol A based high molecular weight epoxy resin.

### DETAILED DESCRIPTION OF THE INVENTION

One broad embodiment of the present invention relates to coating compositions employing novel high molecular weight poly epoxy ester resins based on the reaction product of cycloaliphatic diglycidyl ether and aromatic fused-ring dicarboxylic acid. More particularly, the coating composition of the present invention includes high molecular weight poly epoxy ester resins with a high level of elongation at break and high tensile toughness which improve coating performance during and after coating and coating deformation processes. For example, the poly epoxy ester resins useful in the coating composition of the present invention may comprise a reaction product of (a) at least a cycloaliphatic diglycidyl ether (DGE), and (b) at least an aromatic fused-ring dicarboxylic acid, such as naphthalene dicarboxylic acid, substituted naphthalene dicarboxylic acid, or mixtures thereof.

The cured coating exhibits improved flexibility without negative impact on other coating properties, such as adhesion to substrates, as well as solvent and retort resistances.

The curable coating composition of the present invention includes, as a first component, an advanced high molecular weight poly epoxy ester resin having the following chemical Structure (I):

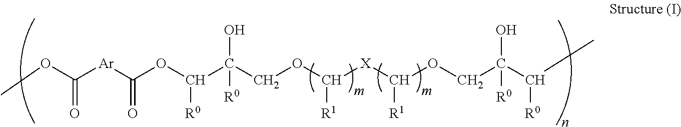

where n is number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical); Ar is a divalent aromatic fused-ring moiety, which is most preferably a divalent naphthalene group, substituted divalent naphthalene group, where the substitute groups include an alkyl, cycloalkyl, an aryl or an aralkyl group or other substituent; and X is cycloalkylene group, including substituted cycloalkylene group, where the substitute group include an alkyl, cycloalkyl, an aryl or an aralkyl group or other substitute group, for example, a halogen, a nitro, a blocked isocyanate, or an alkyloxy group; the combination of cycloalkylene and alkylene groups and the combination of alkylene and cycloalkylene group with a bridging moiety in between.

In one embodiment, the average number of repeating units, n shown in above Structure I, is generally a number from 1 to about 3000, preferably a number from 2 to about 1500, more preferably a number from about 4 to about 1000, even more preferably a number from about 6 to about 500, still more preferably a number from about 8 to about 100, and most preferably a number from about 10 to about 50.

In another embodiment, the weight average molecular weight of the first component, the advanced poly epoxy ester resin in the present invention, is generally above about 300, preferably above about 1000, more preferably above about 2000, even more preferably above about 4000, still more preferably above about 5000 and most preferably about 7000.

In another embodiment, the weight average molecular weight of the first component, the advanced poly epoxy ester resin of the present invention, is generally between about 300 to about 1,000,000, preferably from about 1,000 to about 500,000, more preferably from about 2,000 to about 100,000, even more preferably from about 4,000 to about 50,000, still more preferably from about 5,000 to about 40,000, and most preferably from about 7,000 to about 30,000.

The glass transition temperature of the first component, the advanced poly epoxy ester resin of the present invention, is generally between about −50° C. to about 200° C., preferably from about 0° C. to about 150° C., more preferably from about 10° C. to about 120° C., even more preferably from about 20° C. to about 100° C. and most preferably from about 25° C. to about 90° C.

The elongation at break of the first component, the advanced poly epoxy ester resin of the present invention, is generally between about 4 percent (%) to about 10000%, preferably from about 10% to about 5000%, more preferably from about 20% to about 4000%, even more preferably from about 30% to about 3000%, still more preferably from about 40% to about 2000%, most preferably from about 50% to about 1500%, even most preferably from about 60% to about 1200%, and still most preferably from about 80% to about 1100%.

The tensile toughness at room temperature of the first component, the advanced poly epoxy ester resin of the present invention, is generally between about 0.05 MPa to about 500 MPa, preferably from about 0.05 MPa to about 500 MPa, more preferably from about 0.1 MPa to about 100 MPa, even more preferably from about 0.5 MPa to about 50 MPa, still more preferably from about 0.8 MPa to about 30 MPa, most preferably from about 1.0 MPa to about 20 MPa, even most preferably from about 2.0 MPa to about 15 MPa, and still most preferably from about 3.0 MPa to about 10 MPa.

The first component, the advanced poly epoxy ester resin of the present invention, may comprise a reaction product of (a) cycloaliphatic diglycidyl ether compounds such as a mixture of 1,3 and 1,4 cis and trans cyclohexanedimethanol diglycidyl ether formed during an epoxidation process and (b) aromatic fused-ring dicarboxylic acid compounds, such as naphthalene dicarboxylic acid, substituted naphthalene dicarboxylic acid, or mixtures thereof.

In one embodiment, for example, the preparation of the above advanced poly epoxy ester resins useful in the coating compositions may be illustrated by the following reaction Scheme (I):

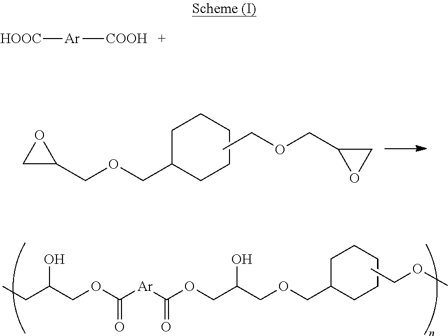

where Ar is a divalent aromatic fused-ring moiety, which is most preferably a divalent naphthalene group, substituted divalent naphthalene group, where the substitute groups include an alkyl, cycloalkyl, an aryl or an aralkyl group or other substituent. The substituent includes, for example, a nitro, a blocked isocyanate, or an alkyloxy group. The diepoxide compound may be, for example as shown above a mixture comprising 1,3 and 1,4 cis and trans cyclohexanedimethanol diglycidyl ether (UNOXOL™ Diol diglycidyl ether (DGE)), which formed during an epoxidation process. Although the advanced poly epoxy ester resin illustrated above is a linear chain without branching, it is possible that small amounts of side-reactions may generate branching and primary hydroxyl groups along the polymer chains. The substantially linear advanced poly epoxy ester resin forms homogeneous coating solutions in suitable coating solvents without any apparent gel particles and/or insoluble fractions.

One preferred example of cycloaliphatic diglycidyl ether of the present invention to build new high molecular weight poly epoxy ester resins used in coating compositions is UNOXOL™ Diol DGE, which is a product mixture comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol. WO2009/142901, incorporated herein by reference, describes an epoxy resin composition comprising such a product mixture and isolation of high purity diglycidyl ether (DGE) therefrom.

Another preferred example of cycloaliphatic diglycidyl ether to build new high molecular weight poly epoxy ester resins used in coating compositions in the present invention is a mixture comprising diglycidyl ether of cis-1,4-cyclohexanedimethanol, a diglycidyl ether of trans-1,4-cyclohexanedimethanol, and a product mixture thereof.

In general, the aliphatic or cycloaliphatic epoxy resin used to prepare a diglycidyl ether reactant, component (a), for use in the advancement reaction of the present invention is prepared by a process (e.g. an epoxidation reaction) comprising reacting (1) an aliphatic or cycloaliphatic hydroxyl-containing material with (2) an epihalohydrin, and (3) a basic acting substance in the presence of (4) a catalyst. The process may optionally comprise (5) a solvent which is substantially inert to reaction with the reactants employed, the intermediates formed and the epoxy resin product produced. The catalyst is preferably a non-Lewis acid catalyst. Said process typically comprises the steps of (a) coupling of the epihalohydrin with the aliphatic or cycloaliphatic hydroxyl-containing material and (b) dehydrohalogenation of the intermediate halohydrin thus formed. The process may be, for example, a phase transfer catalyzed epoxidation process, a slurry epoxidation process, or an anhydrous epoxidation process. A detailed description of the aliphatic or cycloaliphatic epoxy resin and the processes for preparing the same is provided in WO/2009/142901, which is incorporated herein by reference.

Aliphatic or cycloaliphatic hydroxyl-containing materials, component (1), which may be employed in the epoxidation process of the present invention may include for example any one or more of the following: (A) cyclohexanedialkanols and cyclohexenedialkanols such as UNOXOL™ Diol (cis-, trans-1,3- and 1,4-cyclohexanedimethanol) as a preferred cyclohexanedialkanol; (B) cyclohexanolmonoalkanols and cyclohexenolmonoalkanols, such as trans-2-(hydroxymethyl)cyclohexanol or 1-phenyl-cis-2-hydroxymethyl-r-1-cyclohexanol; (C) decahydronaphthalenedialkanols, octahydronaphthalenedialkanols and 1,2,3,4-tetrahydronaphthalenedialkanols, such as 1,2-decahydronaphthalenedimethanol; (D) bicyclohexanedialkanols or bicyclohexanolmonoalkanols, such as bicyclohexane-4,4′-dimethanol; (E) bridged cyclohexanols, such as hydrogenated bisphenol A (4,4′-isopropylidenediphenol); (F) other cycloaliphatic and polycycloaliphatic diols, monol monoalkanols, or dialkanols such as, cyclopentane-1,3-diol; or (G) aliphatic hydroxyl-containing materials such as alkoxylated phenolic reactants; as described in pages 7 to 14 of co-pending U.S. Patent Application Ser. No. 61/388,072 entitled “ADVANCED POLYEPOXY ESTER RESIN COMPOSITIONS”, filed of even date herewith by Xin Jin et al. (Attorney Docket No. 69255), such pages incorporated herein by reference.

The epichlorohydrin, component (2); the basic acting substance, component (3); the non-Lewis acid catalyst, component (4); and the optional solvent, component (5) useful in the present invention may be selected from the same components as described in pages 14 to 16 of co-pending U.S. Patent Application Ser. No. 61/388,072 (Attorney Docket No. 69255), such pages incorporated herein by reference.

Epoxy resins of cycloaliphatic or polycycloaliphatic diols may beneficially be employed in a mixture with one or more of the epoxy resins selected from the epoxy resins prepared from aliphatic or cycloaliphatic hydroxyl-containing materials described above to provide additional advanced high molecular weight poly epoxy ester resin compositions of the present invention. Epoxy resins of other kinds of diols may also beneficially be employed in a mixture comprising one or more of the epoxy resins selected from the epoxy resins of aliphatic or cycloaliphatic hydroxyl-containing materials described above to provide additional advanced high molecular weight poly epoxy ester resin compositions of the present invention.

Epoxy resins prepared from reaction of aliphatic and cycloaliphatic diols using non-Lewis acid processes typically contain a significant amount of oligomeric product with an epoxide functionality of 3. Because of the presence of functionality higher than 2 epoxide groups per molecule, an excess of these oligomers can induce unwanted branching, excessive viscosity, premature crosslinking or gelation. Thus, the epoxy resins used to prepare the compositions of the present invention should have an amount of diglycidyl ether component which allows the advancement reaction to progress to completion without the aforementioned problems. Thus, the amount of oligomer content in the epoxy resin is generally from 0 percent by weight (wt %) to about 10 wt %, preferably from about 0.01 wt % to about 5 wt % and more preferably from about 0.1 wt % to about 0.5 wt %.

Monoglycidyl monol ethers may also comprise a component of the epoxy resins used to prepare the compositions of poly epoxy ester resins in the present invention. Because the monoglycidyl ether component generally functions as a chain terminator in the advancement reaction, it is present in an amount which does not hinder the desired extent of molecular weight build and other such properties. Thus, the amount of oligomer content in the epoxy resin is generally from 0 wt % to about 20 wt %, preferably from about 0.01 wt % to about 10 wt % and more preferably from about0.1 wt % to about 5 wt %.

The aromatic fused-ring dicarboxylic acid used as component (b) in the advancement reaction to produce the advanced poly epoxy ester resin product of the present invention may comprise any substituted or unsubstituted aromatic fused-ring structures bearing two carboxylic acid groups in any ring positions. The fused-ring structures may comprise naphthalene, substituted naphthalene and any ring-annulated benzene with the combination of aryl and aliphatic substituent groups.

The aromatic fused-ring dicarboxylic acid useful as component (b) in the advancement reaction to produce the high molecular weight poly epoxy ester resin product of the present invention may comprise dicarboxylic acid with a fused-ring moiety having the following general structure:

HOOC—Ar—COOH Structure (II)

where Ar is a divalent aromatic fused-ring moiety, which is most preferably a divalent naphthalene group, substituted divalent naphthalene group, where the substituent groups include an alkyl, cycloalkyl, an aryl or an aralkyl group or other substituent. The substituent includes, for example, a nitro, or an alkyloxy group. The aromatic fused-ring dicarboxylic acid may comprise one or more saturated rings and one or more aromatic rings. The aromatic fused-ring dicarboxylic acid useful in the present invention may include, but is not limited to, a 2,6-naphthalene dicarboxylic acid, a nonsubstituted or substituted naphthalene dicarboxylic acid with two —COOH groups at any positions, a nonsubstituted or substituted tetrahydronaphthalene dicarboxylic acid with two —COOH groups at any positions, a nonsubstituted or substituted dihydronaphthalene dicarboxylic acid with two —COOH groups at any positions, a nonsubstituted or substituted anthracene dicarboxylic acid with two —COOH groups at any positions, a nonsubstituted or substituted acenaphthene dicarboxylic acid with two —COOH groups at any positions, a nonsubstituted or substituted acenaphthylene dicarboxylic acid with two —COOH groups at any positions, a nonsubstituted or substituted indan dicarboxylic acid with two —COOH groups at any positions, any aromatic fused ring compound with dicarboxylic acid structures and mixtures thereof and the like.

The resultant high molecular weight poly epoxy ester resin contains ester linkages and hydroxyl groups characteristic of the poly epoxy ester resin advancement reaction.

The monomer molar ratios between the aromatic fused-ring dicarboxylic acid compounds and the cycloaliphatic diglycidyl ether compounds, such as a mixture of 1,3 and 1,4 cis and trans cyclohexanedimethanol diglycidyl ether (e.g. UNOXOL™ Diol DGE) may vary from about 5:1 to about 1:5, preferably from about 1:1.5 to about 1.5:1, and more preferably from about 1:1.1 to about 1.1:1. The monomer molar ratios are used to obtain high molecular weight advanced poly epoxy ester resins. As described in polymer textbooks, such as George Odian in Principles of Polymerization, 4^{th} edition, incorporated herein by reference, a near stoichiometric monomer ratio, e.g. molar ratio between aromatic fused-ring dicarboxylic acid and cycloaliphatic diglycidyl ether from about 1.1:1 to about 1:1.1, is used to prepare substantially linear high molecular weight poly epoxy ester resins. A significant deviation from stoichiometric monomer ratio would lead to oligomers or low molecular weight epoxy products.

In another embodiment of the present invention, an aromatic fused-ring dicarboxylic acid, such as a naphthalene dicarboxylic acid, may beneficially be employed in a mixture comprising one or more single ring aromatic dicarboxylic acids selected from any substituted or unsubstituted aryl structures bearing two carboxylic acid groups in any ring positions, where the aryl structures may comprise for example benzene, substituted benzene and ring-annulated benzene, or the combination of aryl and aliphatic substitute groups, to provide additional advanced high molecular weight poly epoxy ester resin compositions of the present invention. This method beneficially allows for incorporation of different structures into the advanced high molecular weight poly epoxy poly epoxy ester resin compositions as well as control of the polymeric properties and improvement of coating performance.

In another embodiment of the present invention, use of a mixture comprising aromatic fused-ring dicarboxylic acids selected from any substituted or unsubstituted aryl structures bearing two carboxylic acid groups in any ring positions can be employed to provide a reactive epoxy terminated oligomeric product, either in situ or in a separate reaction, which can then be further reacted with an aromatic fused-ring dicarboxylic acid to give an advancement product of high molecular weight poly epoxy ester resin of the present invention. In another embodiment of the present invention, use of a an aromatic fused-ring dicarboxylic acid can be employed to provide a reactive epoxy terminated oligomeric product, either in situ or in a separate reaction, which can then be further reacted with a mixture comprising aromatic dicarboxylic acid selected from any substituted or unsubstituted aryl structures bearing two carboxylic acid groups in any ring positions to give an advancement product of high molecular weight poly epoxy ester resin of the present invention.

In another embodiment of the present invention other acid function providing monomers such as non-aromatic diacids or anhydrides may be used in addition to the aromatic diacid. The non-aromatic diacids or anhydrides may be saturated or contain a double bond which is polymerizable by free radical mechanism. Maleic acid anhydride may be an example of an acid function providing monomer having a double bond which is polymerizable by free radical mechanism. The introduction of the a double bond which is polymerizable by free radical mechanism into the backbone of the resulting poly epoxy ester resin could be useful as reaction site with other acid functional monomers which are polymerizable by free radical mechanism, such as (meth) acrylic acid and vinylic monomers not containing an acid group such as acrylic acid esters, styrene and the like, rendering resins which can be dispersed by at least partially neutralizing of the derived modified product with a base such as dimethanol amine applying the methods known to those skilled in the art to make waterborne dispersions as described, for example, in WO2005080517, incorporated herein by reference.

In another embodiment of the present invention, use of a reactant with moieties possessing different reactivity toward the epoxide group can be employed to provide a reactive oligomeric product, either in situ or in a separate reaction, which can then be further reacted to give an advancement reaction product of the present invention. Then this reactive oligomeric product can be further reacted with the same or different reactants to produce an advanced poly epoxy ester resin product of the present invention.

As a representative example, a monophenolmonocarboxylic acid may be reacted with an epoxy resin under conditions which substantially favor reaction of the phenolic hydroxyl moiety leaving the carboxylic acid moiety substantially unreacted. The resultant carboxylic acid terminated product may then be reacted with an additional epoxy resin or an additional epoxy resin plus additional mixture comprising an aromatic fused-ring dicarboxylic acid to produce the advancement product of the present invention. As another representative example, a diphenol may be reacted with an epoxy resin to produce an epoxy terminated oligomer product. The resultant epoxy terminated oligomer product may then be reacted with an additional aromatic fused-ring dicarboxylic acid or an additional epoxy resin plus additional mixture comprising aromatic fused-ring dicarboxylic acid to produce the advancement high molecular weight poly epoxy ester resin of the present invention. This method beneficially allows for incorporation of different structures into the product as well as control of the position of various chemical structures within the product. Representative of the monophenolmonocarboxylic acids are p-hydroxybenzoic acid, o-hydroxybenzoic acid, m-hydroxybenzoic acid, p-hydroxyphenylacetic acid, 1-hydroxy-4-carboxynaphthalene, 2-hydroxy-7-carboxynaphthalene, mixtures thereof and the like.

In another embodiment of the present invention, use of a reactant with moieties possessing reactivity toward the epoxide end groups of poly epoxy ester resin or hydroxyl group along the polymer chain can be employed to modify the chemical structures of the high molecular weight poly epoxy ester resin. It may also possible to incorporate one or more monomers with functional groups other than dicarboxylic acid and epoxide directly into the synthesis of the poly epoxy ester resin to modify the chemical structures of poly epoxy ester resins. The modified poly epoxy ester resin products in the manner given above may possess enhanced physical and/or mechanical properties useful for various applications such as for can coating resins prepared therefrom. Thus, modification of properties such as adhesion to a metal substrate, toughness, processability, and other improved properties may be achieved.

The examples of polymer modifications include, but not limit to, capping of the poly epoxy ester resin with unsaturated acid monomers such as acrylic acids for radiation curing applications, and making water dispersible resins for use in waterborne spray and roller coat applications for beverage and food cans. For example, the resin may be made water dispersible as follows: (i) by adding water dispersible acrylic or polyester resins, (ii) by extending the epoxy resin with water dispersible acrylic or polyester resins, (iii) by grafting with acid functional monomers which contain a double bond which is polymerizable by free radical mechanism such as (meth) acrylic acid and vinylic monomers not containing an acid group such as acrylic acid esters, styrene and the like, (iv) reacting with phosphoric acid and water and the like or (v) by at least partially neutralizing of the reaction product of (i) to (iv) above with a base such as dimethanol amine applying the methods known to those skilled in the art to make water dispersible epoxy resins and polyesters and rendering waterborne dispersions as described, for example, in EP17911, U.S. Pat. No. 6,306,934, WO2000039190, WO2005080517, incorporated herein by reference.

The resin of the present invention as such could further undergo additional processes such as hydrogenation of any unsaturations or aromatic moieties to yield a resin which is fully saturated.

The preparation of a substantially linear high molecular weight poly epoxy ester resin of the present invention is achieved by adding to a reactor: a cycloaliphatic diglycidyl ether, an aromatic dicarboxylic acid, optionally a catalyst, and optionally a solvent; and then allowing the components to react under reaction conditions to produce the high molecular weight poly epoxy ester resin. The components may be mixed in any order. The components are heated until the desired degree of reaction is achieved.

The reaction conditions to form the substantially linear high molecular weight poly epoxy ester resin include carrying out the reaction under a temperature, generally in the range of from about 20° C. to about 250° C.; preferably from about 100° C. to about 250° C.; more preferably, from about 125° C. to about 225° C.; and even more preferably, from about 150° C. to about 200° C. The pressure of the reaction may be from about 0.1 bar to about 10 bar; preferably, from about 0.5 bar to about 5 bar: and more preferably, from about 0.9 bar to about 1.1 bar.

In a preferred embodiment, one or more suitable reaction catalysts may be employed in the practice of the present invention. Catalysts used to prepare the compositions of the present invention may be selected, for example, from one or more of, metal salts such as an alkali metal salt or an alkaline earth metal salt, a tertiary amine, a quaternary ammonium salt, a quaternary phosphonium salt, a phosphine and the like, and mixtures thereof. Preferably, the catalyst used in the present invention is tetraphenylphosphonium bromide, any aliphatic or aromatic substituted phenylphosphonium bromide or mixtures thereof.

The reaction catalyst is generally employed in an amount of from about 0.0010 wt % to about 10 wt %, preferably from about 0.01 wt % to about 10 wt %; more preferably from about 0.05 wt % to about 5 wt %, and most preferably from about 0.1 wt % to about 4 wt %, based on the combined weight of monomer compounds used.

The reaction process to prepare the substantially linear high molecular weight poly epoxy ester resin of the present invention may be a batch or a continuous. The reactor used in the process may be any reactor and ancillary equipment well known to those skilled in the art.

Another embodiment of the present invention is directed to a curable high molecular weight poly epoxy ester resin coating composition comprising (i) the above advanced poly epoxy ester resin of Structure (I); (ii) at least one curing agent; (iii) at least one curing catalyst; (iv) optionally, at least one solvent; and (v) optionally, at least additive.

The first component (i) of the curable advanced poly epoxy ester resin coating composition comprises the advanced poly epoxy ester resin, as described above. The concentration of first component (i), the high molecular weight poly epoxy ester resin, used in the curable poly epoxy ester resin composition of the present invention may range generally from about 99.9 wt % to about 10 wt %; preferably, from about 99 wt % to about 50 wt %; more preferably from about 98 wt % to about 75 wt %; and even more preferably, from about 95 wt % to about 85 wt %. Generally, the amount of high molecular weight poly epoxy ester resin used is selected based on the desired balance of properties of the resulting cured product.

A curing agent useful for the curable high molecular weight poly epoxy ester resin composition of the present invention may comprise any conventional curing agent known in the art for curing epoxy resins such as for example an epoxy resin, a phenolic resole, an amino formaldehyde resin, an amido formaldehyde resin, or an anhydride resin, and the like. The crosslinker (curing agent) may also selected from crosslinkers with other reactive groups such as active alcoholic OH groups, e.g. alkylol such as ethylol or other methylol groups, epoxy group, carbodiimide group, isocyanate group, blocked isocyanate group, aziridinyl group, oxazoline group, acid groups and anhydride groups, i-butoxymethylacrylamide and n-butoxymethylacrylamide groups and the like; unsaturated groups cured with a radial initiator and/or radiation, and mixtures thereof.

The ratios between the high molecular weight poly epoxy ester resin, component (i); and the crosslinker component (ii) of the curable high molecular weight poly epoxy ester resin composition, may vary and can depend on various factors such as the type of crosslinker used. However, in general the weight ratio may be from about 0.1 wt % to about 90 wt %, preferably from about 1 wt % to about 50 wt %, more preferably from about 2 wt % to about 25 wt %, and most preferably from about 5 wt % to about 15 wt %. The amount of the curing agent used in the curable advanced high molecular weight poly epoxy ester resin composition generally is selected based on the desired balance of properties of the resulting cured product.

In preparing the curable advanced high molecular weight poly epoxy ester resin composition of the present invention, at least one curing catalyst may be used to facilitate the curing reaction of the advanced high molecular weight poly epoxy ester resin with the at least one curing agent. The curing catalyst useful in the present invention may include, for example an acid such as phosphoric acid or an organosulfonic acid or a base such as a tertiary amine or an organometallic compound such as organic derivative of tin, bismuth, zinc, or titanium or an inorganic compound such as oxide or halide of tin, iron, or manganese; and mixtures thereof.

The curing catalyst is generally employed in an amount of from about 0.01 wt % to about 10 wt %; preferably from about 0.05 wt % to about 5 wt %, and more preferably from about 0.1 wt % to about 2 wt %, based on the combined weight of the advanced poly epoxy ester resin and curing agent used.

Also to facilitate the curing of high molecular weight poly epoxy ester resin with the at least one curing agent, a solvent may be used in preparing the curable high molecular weight poly epoxy ester resin composition of the present invention. For example, one or more organic solvents well known in the art may be added to the advanced high molecular weight poly epoxy ester resin composition. For example, aromatics such as xylene, ketones such as methyl ethyl ketone and cyclohexanone, and ethers such as monobutyl ethylene glycol ether and diethylene glycol dimethyl ether (diglyme), alcohols such as butanol; and mixtures thereof, may be used in the present invention.

The concentration of the solvent used in the present invention may range generally from 0 wt % to about 90 wt %, preferably from about 0.01 wt % to about 80 wt %, more preferably from about 1 wt % to about 70 wt %, and most preferably from about 10 wt % to about 60 wt %. Viscosity is too high or solvent is wasted when the above concentration ranges are not used. However, it is possible to formulate the coating compositions without any solvent, such as the applications in power coatings.

Additives known useful for the preparation, storage, and curing of the typical advanced poly epoxy ester resin composition may be used in the curable high molecular weight poly epoxy ester resin composition as optional additional elements, such as reaction catalysts, resin stabilizers, defoamers, wetting agents, curing catalysts, pigments, dyes and processing aids. An assortment of additives may be optionally added to the compositions of the present invention including for example, other catalysts, solvents, other resins, stabilizers, fillers such as pigments, dyes or corrosion inhibitors, plasticizers, catalyst de-activators, and mixtures thereof.

Other optional additives that may be added to the curable composition of the present invention may include, for example, wetting agents, lubricants, defoamers, fillers, adhesion promotors, slip agents, anti cratering agents, plasticizers, catalyst de-activators, acrylic acid/vinylic monomers for grafting on the poly epoxy ester resin backbone to achieve water dispersibility, polymeric coreactants such as an acrylic resin or polyester resin; resins such as polyesters, acrylic resins, polyolefins, urethane resins, alkyd resins, polyvinylacetates; dispersion with acid functional/non ionic surfactants in water; and mixtures thereof and the like.

Generally, the concentration of the optional additives used in the present invention may range generally from 0 wt % to about 10 wt %, preferably from about 0.01 wt % to about 10 wt %, and more preferably from about 1 wt % to about 5 wt %.

The curable advanced poly epoxy ester resin products used in the curable coating compositions of the present invention are preferably polymers with weight average molecular weight generally between about 300 to about 1,000,000, preferably from about 1,000 to about 500,000, more preferably from about 2,000 to about 100,000, even more preferably from about 4,000 to about 50,000, still more preferably from about 5,000 to about 40,000, and most preferably from about 7,000 to about 30,000.

The glass transition temperature of the curable advanced poly epoxy ester resin products used in the curable coating compositions of the present invention is generally between about −50° C. to about 200° C., preferably from about 0° C. to about 150° C., more preferably from about 10° C. to about 120° C., even more preferably from 20° C. to about 100° C., and most preferably from 25° C. to about 90° C.

The elongation at break of the curable advanced poly epoxy ester resin products used in the curable coating compositions of the present invention is generally between about 4% to about 10000%, preferably from about 10% to about 5000%, more preferably from 20% to about 4000%, even more preferably from about 30% to about 3000%, still even more preferably from about 40% to about 2000%, yet even more preferably from about 50% to about 1500%, still even most preferably from about 60% to about 1200%, and most preferably from about 80% to about 1100%.

The tensile toughness of the curable advanced poly epoxy ester resin products used in the curable coating compositions of the present invention is generally between about 0.05 MPa to about 500 MPa, preferably from about 0.1 MPa to about 100 MPa, more preferably from about 0.5 MPa to about 50 MPa, even more preferably from about 0.8 MPa to about 30 MPa, still even more preferably from about 1.0 MPa to about 20 MPa, yet even more preferably from about 2.0 MPa to about 15 MPa, and most preferably from about 3.0 MPa to about 10 MPa.

The curable the advanced high molecular weight poly epoxy ester resin composition formulation or composition of the present invention can be cured under conventional processing conditions to form a film, a coating, a foam or a solid. The process to produce the cured advanced high molecular weight poly epoxy ester resin products of the present invention may be performed by gravity casting, vacuum casting, automatic pressure gelation (APG), vacuum pressure gelation (VPG), infusion, filament winding, lay up injection, transfer molding, prepregging, dipping, coating, such as roller coating, dip coating, spray coating and brush coating, and the like.

The curing reaction conditions include, for example, carrying out the reaction under a temperature, generally in the range of from about 0° C. to about 300° C.; preferably, from about 20° C. to about 250° C.; and more preferably, from about 100° C. to about 220° C.

The pressure of the curing reaction may be carried out, for example, at a pressure of from about 0.01 bar to about 1000 bar; preferably, from about 0.1 bar to about bar 100; and more preferably, from about 0.5 bar to about 10 bar.

The curing of the curable advanced epoxy resin composition may be carried out, for example, for a predetermined period of time sufficient to cure or partially cure (B-stage) the composition. For example, generally the curing time may be chosen between about 2 seconds to about 24 hrs, preferably between about 5 seconds to about 2 hours, more preferably between about 5 seconds to about 30 minutes, and even more preferably between about 8 seconds to about 15 minutes. A B-staged composition of the present invention may then be completely cured at a later time using the aforementioned conditions.

The curing process of the present invention may be a batch or a continuous process. The reactor used in the process may be any reactor and ancillary equipment well known to those skilled in the art.

The resulting cured coating composition displays excellent physical-mechanical properties, such as unusually high flexibility, good retort resistance and excellent adhesion before and after retorting processes, good organic solvent resistance and good visual blush appearance useful for metal food packaging applications.

The flexibility of the cured coating composition was measured by Wedge Bend Flexibility. The failure percentage measured by Wedge Bend Flexibility of the resulting cured coating composition is generally below about 50%, preferably below about 25%, more preferably below about 15%, even more preferably below about 10%, still even more preferably below about 5%, yet even more preferably below about 4%, still even more preferably below about 3%, yet even more preferably below about 2%, and most preferably below about 1%.

The chemical solvent resistance of the cured coating composition was measured by MEK Double Rub. The solvent resistance measured by MEK Double Rub of the resulting cured coating composition is generally above about 25, preferably above about 50, more preferably between about 50 to about 200, even more preferably between about 50 to about 150, and most preferably between about 50 to about 125.

The retort resistance and adhesion before and after retorting processes of the cured coating composition was characterized by retort resistance measurement in lactic acid solution. The retort resistance of the resulting cured coating composition preferably has a visual scale standard ranking of 5, which indicates resulting cured coating composition does not have any cracking, blushing, blisters and/or adhesion failure after the retort treatment.

The curable coating composition formulation or composition of the present invention can be cured under conventional processing conditions to form a film, a coating or a solid.

As an illustration of the present invention, in general, the resulting cured coatings are useful in applications, such as for example, encapsulations, castings, moldings, potting, encapsulations, injection, resin transfer moldings, composites, and the like.

In one embodiment, the coatings are useful for food and beverage containers. The resins can be further modified, such as acrylic grafted and modifications of functional groups along the polymer chains, prior to use. The coating compositions prepared therefrom can be applied to metal substrate and cured under mild heat curing conditions to provide smooth and highly flexible coatings. The novel coating compositions provide a method and a composition for a coating composition which shows unusually high flexibility, excellent adhesion to the metal before and after retorting processes and good visual blush appearance useful for metal food packaging applications. The present invention is particularly useful for internal protective coatings for cans as well as external protective coatings for cans such as washcoats, repair coats for scoring areas of easy open ends or welding zones, as corrosion protective base coat or as overprint varnish in decorative external coating systems.

### EXAMPLES

The following examples and comparative examples further illustrate the present invention in detail but are not to be construed to limit the scope thereof.

Various terms and designations are used in the following Examples, including for example the following:

UNOXOL™ Diol is a mixture of cis-, trans-1,3- and 1,4-cyclohexanedimethanol obtained from The Dow Chemical Company. A high purity (>99.0 area % by gas chromatography) product mixture of diglycidyl ether of cis-, trans-1,4-cyclohexanedimethanol and a product mixture of a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclo-hexanedimethanol (UNOXOL™ Diol DGE) were prepared and purified according to WO2009/142901. Likewise, a high purity product mixture of diglycidyl ether of cis-, trans-1,4-cyclohexanedimethanol (1,4-CHDM DGE) was prepared and purified using the same method according to WO2009/142901.

Methylon 75108 is an allyl ether phenol-based phenolic resin crosslinker obtained from Durez Corporation. Byk-310 is a kind of silicone additive obtained from Byk Chemie. DER™ 669E is a bisphenol A based high molecular weight 9-type epoxy resin product obtained from The Dow Chemical Company. Catalyst A2 is a 70% tetrabutylphosphonium acetate-acetic acid complex in methanol obtained from Deepwater Chemicals. All other chemicals were obtained from Sigma-Aldrich used as received, except where otherwise noted.

Standard analytical equipment and methods are used in the following Examples, including for example the following:

Molecular Weight Measurement

Gel permeation chromatography (GPC) is used to measure the molecular weight and molecular weight distribution of advanced high molecular weight poly epoxy ester resins. The polymeric samples were diluted to about 0.25 wt % concentration with eluent and analyzed using the conditions below: columns: Polymer Labs 5 μm, 50 Å, 100 Å, 1000 Å, and 1000 Å mono-pore size columns (4 in series); detector: Viscotek TDA 302 with triple-detection system. Differential reflective index (DRI) detector was used for relative MW calculations; eluent: Tetrahydrofuran; flow: 1 mL/min; temperature: 40° C.; injection: 100 μL; calibration: Polymer Laboratories PS-2 linear polystyrene with 3rd order fitting.

Glass Transition Temperature Measurement

Differential scanning calorimetry (DSC) is used to characterize the glass transition temperature (Tg) of advanced high molecular weight poly epoxy ester resins. The equipment is Q1000 DSC from TA Instruments and the testing conditions are two heating and one cooling scans between −50° C. and 250° C. at 10° C./min

Microtensile Measurement

Tensile test is a common measurement used in the industry for many years to characterize toughness, elongation and the ability to resist failure under tensile stress. Stress-strain behavior of advanced resins is measured using ASTM D 1708 microtensile specimens. This microtensile test consists of pulling a sample of material until it breaks with an Instron™ at 20 mm/min at 21° C. with a 200 lb load cell with pneumatic grips. The specimens tested may have a rectangular cross section. From the load and elongation history, a stress-strain curve is obtained with the strain being plotted on the x-axis and stress on the y-axis. The elongation at break is defined as the strain at which the specimen breaks. The tensile toughness is defined as the area under the entire stress-strain curve up to the fracture point. Tensile toughness and elongation at break are reported from an average of 5 specimens.

Coating Thickness Measurements

The thickness measurements are performed basically according to A.S.T.M. D 1186-93; “Non-destructive measurement of dry film thickness of non magnetic coatings applied to a ferrous base” using a PERMASCOPE D-211D, coating thickness gauge.

The sample panel without any coating is zeroed in and then coated panels are measured using a probe for ferrous materials and the measured thickness is reported in [μm].

Methyl Ethyl Ketone (MEK) Double Rubs Test

The MEK test is performed basically according to A.S.T.M. D 5402. The flat end of a hammer hemispherical having a weight of two pounds is used. A normal cheese cloth “VILEDA 3168” is bound around the hammer end. It is soaked with MEK. The hammer is brought onto the coating and moved forth-and-back over the whole coating, being one double rub. Care should be taken not to put any pressure on the hammer. After every 25 double rubs the tissue is re-soaked. This is repeated until the coating is rubbed off to such an extent that the coating is scratched. This procedure is carried out until the maximum of 200 are reached.

Wedge Bend Flexibility Test

The wedge bend flexibility test is carried out as follows: A tapered 180 degree bend in the panel is formed by first bending it to 180° with a radius of about 0.5 cm and coating on the outside of the bend. Then one side of the bend was completely flattened to a near zero radius with an impactor at 40 in. lbs. The stressed surface is subjected to a tape pull and then rubbed with a solution of copper sulfate (mixture of 10 g of copper sulfate, 90 g of water and 3 g of sulfuric acid). Anywhere the coating has cracked dark spots appear indicating failure. The amount of coating failure (in mm) along the length of the wedge bend, which is 100 mm, is recorded as “% failure.”

Retort Resistance in Lactic Acid Solution

Lactic acid retort resistance (LAR) test is carried out as follows: The coated and 180 bended panels were immersed in 2% lactic acid solution in water. The samples were loaded in an autoclave retorted at 121° C. for 30 minutes. Then the autoclave was cooled down to below 50° C. before opening. The panels were removed from the autoclave and the coatings were evaluated using a visual scale of 5-0 in which 5 is considered the best and 0 is considered the worst. The visual scale standards are: 5: no blush or blisters on bent or flat sections; 4: no blush or blisters on flat section; 3: blush but no blisters on flat section; 2: blush with small blisters on flat section; 1: blush with many large blisters on flat section and 0: total coating destruction.

Adhesion Test (After Retort Resistance)

The adhesion test was carried out as follows: Place the centre of a piece of tape over the coating area after the retort resistance measurement in 2% lactic acid solution. Within 30±10 seconds of application, remove the tape by seizing the free end and rapidly pulling it off at as close to an angle of 180 degrees as possible. Any sign of removal of coating by the tape indicates adhesion failure.

### Synthesis Example 1

### Preparation of Poly Epoxy Ester Resin Comprising UNOXOL™ Diol DGE and 2,6-Naphthalenedicarboxylic Acid

A mixture of 20.0 g 2,6-naphthalenedicarboxylic acid, 26.2 g UNOXOL™ Diol DGE, and 1.2 g tetraphenylphosphonium bromide and 141.9 g diethylene glycol dimethyl ether (diglyme) was agitated and heated to 135° C. in a 500 mL 3-neck flask with a condenser and nitrogen purge. After reaction at 135° C. for 2 hours, the mixture was further heated to 163° C. The polymerization was monitored by the titration of residual epoxy groups and acid groups. The reaction was stopped after 6 hours at 163° C. The polymer solution was precipitated into 750 mL of ice and methanol mixture within a blender. The polymer was collected, washed with methanol three times and dried a vacuum oven at 60° C. for 24 hours. The polymer product is a light-yellow clear solid. Its glass transition temperature is 51° C. and its weight average molecular weight is 23200.

### Synthesis Example 2

### Preparation of Poly Epoxy Ester Resin Comprising 1,4-CHDM DGE and 2,6-Naphthalenedicarboxylic Acid

A mixture of 15.0 g phthalic acid, 19.2 g 1,4-CHDM DGE (Epoxy Equivalent Weight (EEW)=128.2, purity by gas chromatography=99.0 area %), 0.51 g tetraphenylphosphonium bromide and 104.1 g diethylene glycol dimethyl ether (diglyme) was stirred and heated to 135° C. in a 250 mL 3-neck flask with a condenser and nitrogen purge. After reaction at 135° C. for 15 hours, the mixture was further heated to 163° C. The polymerization was monitored by the titration of residual epoxy groups and acid groups. The reaction was stopped after 4.4 hours at 163° C. The polymerization was monitored by the titration of residual epoxy groups and acid groups. The reaction was stopped after 1.5 hours at 135° C. The polymer solution was precipitated into 750 ml of ice and methanol mixture within a blender. The polymer was collected, washed with methanol three times and dried a vacuum oven at 60° C. for 24 hours. The polymer product is a light-yellow clear solid. Its glass transition temperature is 45.6° C. and its weight average molecular weight is 12160.

### Comparative Synthesis Example A

### Preparation of Poly Epoxy Ester Resin Comprising UNOXOL™ Diol DGE and Isophthalic Acid

A mixture of 16.0 g isophthalic acid, 27.2 g UNOXOL™ Diol DGE, and 0.6 g tetraphenylphosphonium bromide and 134.1 g diethylene glycol dimethyl ether (diglyme) was stirred and heated to 135° C. in a 250 mL 3-neck flask with a condenser and nitrogen purge. The polymerization was monitored by the titration of residual epoxy groups and acid groups. The reaction was stopped after 2 hours at 135° C. The polymer solution was precipitated into 750 mL of ice and methanol mixture within a blender. The polymer was collected, washed with methanol three times and dried a vacuum oven at 60° C. for 24 hours. The polymer product is a light-yellow clear solid. Its glass transition temperature is 28° C. and its weight average molecular weight is 12250.

### Comparative Example B

### Commercial Epoxy Resin

For further comparison, a commercially available substantially linear high molecular weight epoxy resin, DER™ 669E, was measured by DSC and GPC for its Tg and molecular weight. The glass transition temperature of this bisphenol A based 9-type epoxy resin is 88.3° C. and its weight average molecular weight is 17450.

The results indicate that the new poly epoxy ester resins of the present invention, Examples 1 and 2 and Comparative Example A, have similar weight average molecular weight as the bisphenol A based DER™ 669E, the commercially available high molecular weight epoxy resin.

TABLE I
Microtensile Results of Poly epoxy ester resins

| | Elongation to Break | Tensile Toughness |
|---|---|---|
| Sample # | (%) | (Mpa) |
| Synthesis Example 1 | 79.6 | 6.65 |
| Synthesis Example 2 | 127.7 | 6.61 |
| Comparative Synthesis | 360.9 | 7.97 |
| Example A | | |
| Comparative Example | 0.67 | 0.03 |
| B: DER ™ 669E | | |

The material flexibility and toughness were characterized by Stress-strain behavior under microtensile measurement according to ASTM D 1708. Elongation at break is a parameter to measure the flexibility of polymeric materials and tensile toughness is a measure of the ability of a material to absorb energy in a tensile deformation. The microtensile results of new high molecular weight poly epoxy ester resins are shown in Table I, in comparison with DER™ 669E, the bisphenol A based 9-type high molecular weight epoxy resin. The elongations to break of the new high molecular weight poly epoxy ester resins of the present invention are 100 times and greater than DER™ 669E and their tensile toughness are over 100 times stronger than DER™ 669E. The data in Table I show that those new high molecular weight poly epoxy ester resins of the present invention are more flexible and tough than the 9-type the bisphenol A based epoxy resin, although their weight average molecular weights are in a similar range.

### Example 3

### Curable Composition and Coating Made from Poly Epoxy Ester Resin of Synthesis Example 1

A mixture of 10.000 g poly epoxy ester resin from Example 1, 1.111 g phenolic crosslinker (Methylon 75108), 0.016 g catalyst (85% phosphoric acid), 0.013 g (BYK-310) additive, 26.666 g monobutyl ethylene glycol ether and 6.667 g cyclohexanone was agitated for 16 hours forming a clear solution. The clear solution was filtered through a 1-micron syringe filter and then coated on tin free steel (TFS) panels with a #20 draw down bar. The resultant panels with coatings were dried and cured in an oven at 205° C. for 15 minutes. The thickness of the cured coating was 5.4 micron.

### Example 4

### Curable Composition and Coating Made from Poly Epoxy Ester Resin of Synthesis Example 2

A mixture of 10.000 g poly epoxy ester resin from Example 2, 1.111 g phenolic crosslinker (Methylon 75108), 0.016 g catalyst (85% phosphoric acid), 0.013 g (BYK-310) additive, 26.666 g monobutyl ethylene glycol ether and 6.667 g cyclohexanone was agitated for 16 hours forming a clear solution. The clear solution was filtered through a 1-micron syringe filter and then coated on tin free steel (TFS) panels with a #20 draw down bar. The resultant panels with coatings were dried and cured in an oven at 205° C. for 15 minutes. The thickness of the cured coating was 4.3 micron.

### Comparative Example C

### Curable Composition and Coating Made from Poly Epoxy Ester Resin of Comparative Synthesis Example A

A mixture of 10.000 g poly epoxy ester resin from Comparative Synthesis Example A, 1.111 g phenolic crosslinker (Methylon 75108), 0.016 g catalyst (85% phosphoric acid), 0.026 g (BYK-310) additive, 26.666 g monobutyl ethylene glycol ether and 6.667 g cyclohexanone was agitated for 16 hours forming a clear solution. The clear solution was filtered through a 1-micron syringe filter and then coated on tin free steel (TFS) panels with a #20 draw down bar. The resultant panels with coatings were dried and cured in an oven at 205° C. for 15 minutes. The thickness of the cured coating was 5.0 micron.

### Comparative Example D

### Curable Composition and Coating Made from DER™ 669E

A mixture of 10.000 g DER™ 669E, 1.111 g phenolic crosslinker (Methylon 75108), 0.016 g catalyst (85% phosphoric acid), 0.013 g (BYK-310) additive, 26.666 g monobutyl ethylene glycol ether and 6.667 g cyclohexanone was agitated for 16 hours forming a clear solution. The clear solution was filtered through a 1-micron syringe filter and then coated on tin free steel (TFS) panels with a #20 draw down bar. The resultant panels with coatings were dried and cured in an oven at 205° C. for 15 minutes. The thickness of the cured coating was 5.0 micron.

All cured polymer coatings from Example 3, 4 and Comparative Example C, D are based on the similar coating formulations, except that different polymeric resins are used. All cured coatings are smooth and uniform without visual blush appearance. The flexibility of the cured coatings was evaluated by wedge bend measurement and the solvent resistance of the coatings was tested by MEK double rub tests. The retort resistance and coating adhesion was evaluated following the procedures shown above. The coating evaluation results of all cured epoxy coatings are shown in Table II.

TABLE II
Coating Evaluation Results

| | | MEK | | |
|---|---|---|---|---|
| | Wedge Bend | Double | Retort | |
| Coating # | (Failure %) | Rub | Resistance | Adhesion |
| Example 3 | 0 | 100 | 5 | pass |
| Example 4 | 0 | 100 | 5 | pass |
| Comparative Example C | 0 | 75 | 2 | failed |
| Comparative Example D | 25 | 75 | 5 | pass |

There was not any cracking nor failure in the stressed coating surfaces from Example 3, 4 and Comparative Example C based on new high molecular weight poly epoxy ester resins of the present invention, while the coatings from Comparative Example D based on 9-type high molecular weight DER™ 669E epoxy resin showed 25% failure ratio along the length of the wedge bend. The wedge bend results indicate that the cured coatings based on new poly epoxy ester resins of the present invention are more flexible than those coatings based on the bisphenol A based high molecular weight epoxy resin. In the mean time, the MEK double rub results illustrate that the cured coatings based on new poly epoxy ester resins of the present invention provide slightly better chemical solvent resistance, compared with the coatings from the bisphenol A based high molecular weight epoxy resin, DER™ 669E. Examples 3 and 4 show that the coatings based on high molecular weight poly epoxy ester resins prepared from the naphthalene dicarboxylic acid, for example, 2,6-naphthalene dicarboxylic acid, and cycloaliphatic diglycidyl ether, such as UNOXOL™ Diol DGE and 1,4-CHDM DGE, have excellent retort resistance and maintain their integrity after tape adhesion measurement. However, coatings from Comparative Example C were damaged during the retort resistance and tape adhesion measurements. The results indicate that not all high molecular weight poly epoxy ester resins prepared from the aromatic dicarboxylic acid and cycloaliphatic diglycidyl ether have good adhesion retort resistance. The properties of high molecular weight poly epoxy ester resins comprising an aromatic fused-ring dicarboxylic acid, such as a 2,6-naphthalene dicarboxylic acid, are unique in comparison with the poly epoxy ester resins comprising an aromatic signal ring dicarboxylic acid, such as isophthalic acid.

The coating performance results demonstrate that a cycloaliphatic diglycidyl ether compound and an aromatic fused-ring dicarboxylic acid, such as 2,6-dicarboxylic acid, can be successfully used to make a substantially linear high molecular weight poly epoxy ester resin product, which have a high level of elongation at break and high tensile toughness and can be advantageously used in various coating applications such as for making can coatings. The curable coating compositions comprising high molecular weight poly epoxy ester resins from a cycloaliphatic diglycidyl ether compound, such as a UNOXOL™ Diol DGE, and an aromatic fused-ring dicarboxylic acid, such as 2,6-dicarboxylic acid, show high flexibility, good retort resistance, excellent adhesion to the metal before and after retorting processes and good visual blush appearance useful for metal food packaging applications.

1. A curable coating composition comprising a poly epoxy ester resin polymeric composition having the following chemical structure: 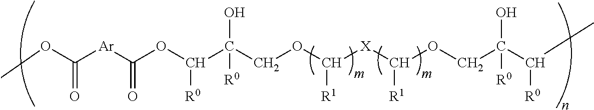
where n is a number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical); Ar is a divalent aromatic fused-ring moiety, which is most preferably a divalent naphthalene group, substituted divalent naphthalene group, where the substitute groups include an alkyl, cycloalkyl, an aryl or an aralkyl group or other substituent; and X is cycloalkylene group, including substituted cycloalkylene group, where the substitute group include an alkyl, cycloalkyl, an aryl or an aralkyl group or other substitute group, for example, a halogen, a nitro, a blocked isocyanate, or an alkyloxy group; the combination of cycloalkylene and alkylene groups and the combination of alkylene and cycloalkylene group with a bridging moiety in between.

2. The curable coating composition of claim 1, including a curing agent.

3. The curable coating composition of claim 1, wherein the poly epoxy ester resin polymeric composition comprises a reaction product of (a) at least one cycloaliphatic diglycidyl ether compound, and (b) at least one aromatic fused-ring dicarboxylic acid.

4. The curable coating composition of claim 3, wherein the at least one cycloaliphatic diglycidyl ether compound comprises diglycidyl ethers of cyclohexanedimethanol.

5. The curable coating composition of claim 3, wherein the at least one cycloaliphatic diglycidyl ether compound comprises a diglycidyl ether of cis-1,3-cyclohexanedimethanol and/or a diglycidyl ether of trans-1,3-cyclohexanedimethanol.

6. The curable coating composition of claim 3, wherein at least one cycloaliphatic diglycidyl ether compound comprises a diglycidyl ether of cis-1,4-cyclohexanedimethanol and/or a diglycidyl ether of trans-1,4-cyclohexanedimethanol.

7. The curable coating composition of claim 3, wherein the at least one cycloaliphatic diglycidyl ether compound comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, and/or a diglycidyl ether of trans-1,4-cyclohexanedimethanol.

8. The curable coating composition of claim 3, wherein the at least one cycloaliphatic diglycidyl ether compound comprises a diglycidyl ether of 1,1′-cyclohexanedimethanol.

9. The curable coating composition of claim 3, wherein the at least one aromatic fused-ring dicarboxylic acid comprises a nonsubstituted or substituted naphthalene dicarboxylic acid with two —COOH groups at any positions, and mixtures thereof and the like.

10. The curable coating composition of claim 3, wherein the at least one aromatic fused-ring dicarboxylic acid comprises a nonsubstituted or substituted 2,6-naphthalene dicarboxylic acid.

11. The curable coating composition of claim 1, wherein the poly epoxy ester resin polymeric composition has a weight average molecular weight of from about 300 to about 1,000,000.

12. The curable coating composition of claim 1, wherein the poly epoxy ester resin polymeric composition has an elongation to break at about 21° C. of from about 4 percent to about 10000 percent as measured by the method ASTM D1708.

13. The curable coating composition of claim 1, wherein the poly epoxy ester resin polymeric composition has a tensile toughness at about 21° C. of from about 0.05 MPa to about 500 Mpa as measured by the method ASTM D1708.

14. The curable coating composition of claim 1, wherein the poly epoxy ester resin polymeric composition has a glass transition temperature of from about −50° C. to about 200° C.

15. The curable coating composition of claim 1, wherein the epoxy resin polymeric composition is water-dispersible.

16. The curable coating composition of claim 15, wherein the epoxy resin polymeric composition is made water-dispersible by (i) reaction with a water-dispersible acrylic; (ii) reaction with a water-dispersible polyester resin; (iii) grafting with at least one unsaturated acid monomer with a double bond which is polymerizable by free radical mechanism; (iv) grafting with at least one acid monomer with a double bond which is polymerizable by free radical mechanism and a vinylic monomer not containing an acid group; or (v) reaction with phosphoric acid and water; and at least partially neutralizing with a base.

17. The curable coating composition of claim 1, wherein the advanced poly epoxy ester resin composition is made water-dispersible by incorporating a dicarboxylic acid with a double bond which is polymerizable by free radical mechanism into the backbone and grafting with at least one acid monomer with a double bond which is polymerizable by free radical mechanism and a vinylic monomer not containing an acid group and at least partial neutralizing with a base.

18. The curable coating composition of claim 1, including at least one crosslinking reagent, at least one curing catalyst, at least one solvent, or mixtures thereof.

19. The curable coating composition of claim 15, including at least one crosslinking reagent, at least one curing catalyst, or mixtures thereof.

20. The curable coating composition of claim 1, including at least one crosslinking reagent, at least one curing catalyst, or mixtures thereof.

21. A cured coating comprising the cured coating composition of claim 1.

22. The coating of claim 21 used in metal packaging.

23. The coating of claim 21 used for internal or external protective coatings for cans.

24. An article made from the composition of claim 1.
